(19) United States
(12) Patent Application Publication
(10) Pub. No.: US 2022/0104529 A1
(43) Pub. Date: Apr. 7, 2022

(54) CHEESE CURD LOG/STICK, AND CHEESE CURD SNACK APPARATUS, PROCESS, AND A METHOD OF MAKING SAME

(71) Applicant: Barron County Cheese, LLC, Barron, WI (US)

(72) Inventor: Gene Graf, Clayton, WI (US)

(73) Assignee: Barron County Cheese, LLC, Barron, WI (US)

(21) Appl. No.: 17/493,547

(22) Filed: Oct. 4, 2021

Related U.S. Application Data
(60) Provisional application No. 63/087,025, filed on Oct. 2, 2020.

(51) Int. Cl. A23P 30/20; A23C 19/084

(52) U.S. Cl. CPC A23P 30/20; A23C 2250/10; A23C 19/084

(57) ABSTRACT

A cheese curd log, including a cheese curd log first end, a cheese curd log second end, and a cheese curd log length, wherein the cheese curd log length extends between the cheese curd log first end and the cheese curd log second end, wherein the cheese curd log is formed into a log via an extrusion process using an extrusion device.

### RELATED APPLICATIONS

This application is related to and claims the benefit of priority of the filing date of U.S. Provisional Patent Application Ser. No. 63/087,025 (Atty. Docket No. 2020-432-BCC), filed Oct. 2, 2020, the contents of which are incorporated by reference herein in its entirety.

### FIELD OF THE INVENTION

The present invention generally relates to cheese curd, and more particularly to a cheese curd log/stick and single serving cheese curd snacks, and an article and method for making a cheese curd log/stick and single serving cheese curd snacks.

### BACKGROUND OF THE INVENTION

In general, cheese curds are moist pieces of curdled milk and, in some cases, may be used in preparing food dishes or they may be eaten alone as a snack. Cheese curds are typically made during the process of creating cheese, when bacterial culture and rennet are added to fresh pasteurized milk to cause the milk to coagulate. The coagulated milk, which is formed of a mixture of whey and curd, is then cut into cubes. These cubes are then typically cooked and pressed to release the whey from the curd, thereby creating the cheese curds. These curds are then often eaten as a snack, a finger food, an appetizer or used in the preparation of food dishes, such as poutine and paneer.

Unfortunately, however, because raw cheese and unpasteurized cheese curds may include bacteria such as listeria, it is illegal to sell cheese curds in the United States unless the bacteria are removed. One such method is to age the cheese curds for at least 60 days to kill the bacteria.

### SUMMARY OF THE INVENTION

A cheese curd log including a cheese curd log first end, a cheese curd log second end, and a cheese curd log length, wherein the cheese curd log length extends between the cheese curd log first end and the cheese curd log second end, wherein the cheese curd log is formed into a log via an extrusion process using an extrusion device.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike in the several Figures:

FIG. 1 is a side view of a cheese curd log/stick secured inside an airtight package, in accordance with one embodiment of the invention.

FIG. 2 is a block diagram showing one embodiment of an apparatus for making the curd log/stick of FIG. 1, in accordance with one embodiment of the invention.

### DETAILED DESCRIPTION OF THE INVENTION

In accordance with the present invention, a unique and novel cheese curd log/stick and single serving cheese curd snack is provided along with an article and method for making the cheese curd log/stick and single serving cheese curd snack. In one embodiment the present invention provides unique and novel cheese curd log(s)/stick(s) and single serving cheese curd snacks. In other embodiments, the present invention provides an article and method for making unique and novel cheese curd log(s)/stick(s) and single serving cheese curd snacks.

Cheese curds are the moist pieces of curdled milk either eaten alone as a snack or used in prepared dishes. Cheese curds are made from fresh pasteurized milk in the process of creating cheese when bacterial culture, and rennet are added to coagulate the milk. After the milk clots it is then cut into uneven cubes or portions. The result is a mixture of whey, and uneven curd pieces. This mixture is then cooked, and pressed to release the whey, from the curd, thereby creating the final product of cheese curd. Fresh cheese curds are often eaten as a snack, finger food, or an appetizer. Cheese curds may be served alone, dressed with an additional flavor and/or served/mixed with another food. Raw cheese or unpasteurized cheese curds are illegal to sell in the United States. However, if the raw cheese is aged for 60 days or more, killing the bacteria, then it becomes legal to sell in the United States. It should be appreciated that cheese curds are a younger, spryer cheddar. In fact, cheese curds are what cheddar is before being formed into blocks and aged. Cheddar cheese is typically aged before being sold, whereas cheese curds are typically fresh. And because cheese curds have sizes and shapes that vary, they are usually packed in bags for sale.

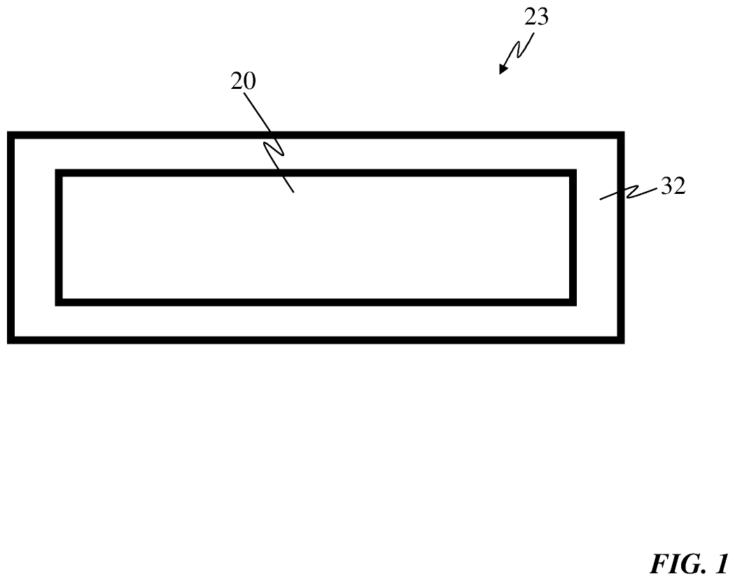

Referring to FIG. 1, one embodiment of the inventive cheese curd log/stick 23, or cheese curd snack 23, is shown, wherein the processed cheese curd 20, has been processed, and secured inside an airtight package or cover or sleeve 32. This airtight package or cover or sleeve 32 is preferably made from a see-through type of plastic material 32, which may be approved for the storage of a food item, such as, for example, the inventive cheese curd log/stick 23, or cheese curd snack 23.

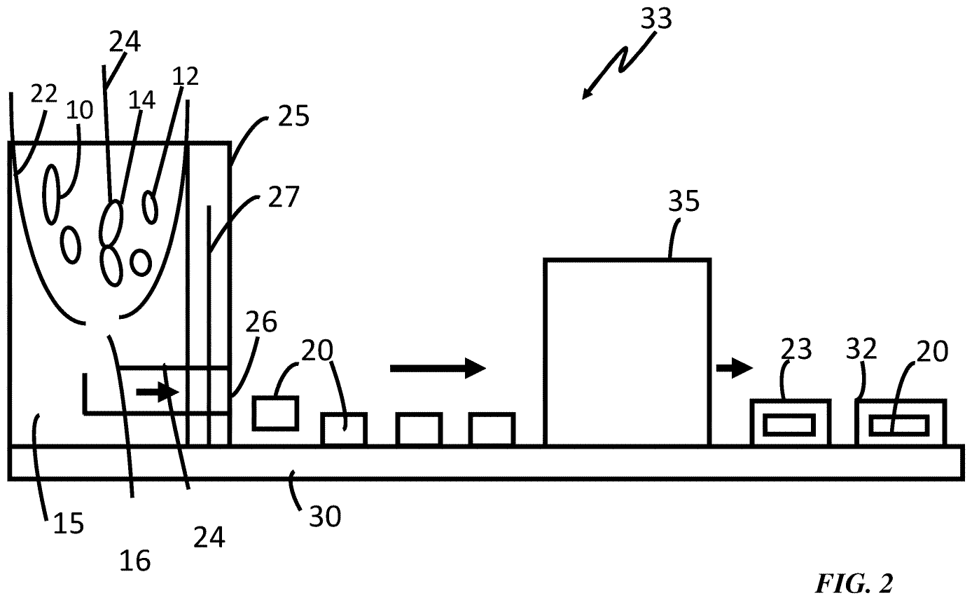

Referring to FIG. 2, one embodiment of an apparatus or process 33, of making the inventive cheese curd log/stick 23, or cheese curd snack 23, is provided, wherein a cheese trim or cheese curd 10, is processed in a cheese curd station 15. The cheese curd station 15, is comprised of a vat or bowl 22, having at least one bottom opening or hole 16, which is connected to at least one opening 26, via at least one tube 24. The cheese curd station 15, also has at least one mixing station 24, having at least one stirrer 14. The cheese trim or cheese curd 10, are placed inside the vat or bowl 22, and the mixing station 24, using the stirrer 14, mixes the cheese trim or cheese curd 10. It should be appreciated that for some applications one can also put in at least one additional material into the vat or bowl 22, which would then be mixed with the cheese trim or cheese curd 10. The mixed cheese curd 10, is then pushed into the hole 16, towards the opening 26, via the at least one tube 24. As the mixed raw cheese curd 10, passes the exit or opening 26, a blade 27, from a cutting station 25, is used to cut the mixed cheese curd 10, into individual logs 20, or sticks 20, and are allowed to be collected over at least one conveyor 30. The conveyor 30, then moves the individual logs 20, or sticks 20, towards at least one packaging station 35, where the individual logs 20, or sticks 20, are wrapped with an airtight (sealed) sleeve or cover or package 32, to form the inventive cheese curd log/stick 23, or cheese curd snack 23. It should be appreciated that FIG. 2 has been used to illustrate that in one embodiment, the apparatus or process 33, is at one location. However, for other embodiments and/or applications, each of the stations 15, 25, 35 could be located at different locations.

It should be appreciated that the pasteurized cheese curd 10, which has been reformed into a stick 20, or a deli log 20, can now be sold as an exact weight snack 23, and/or for exact weight portion slicing 23, and which may also include a new flavor profile that have been developed using the additional material 12. Thus, one can have cheese curd logs 20, and spiced cheese curd logs 20, as well as innovative cheese curd snack sticks 20. This invention allows one to have a combination of different flavors with cheese curds. Thus, it should be understood that this invention includes cheese curds being reformed into a snack stick 20, along with a cheese curd deli log 20, for slicing, as well as creating new flavor profiles for the cheese curd 20.

It should be appreciated that during the conversion and packaging process, the cheese trim 10, may be dispensed directly into a hopper 15. Next, the extrusion process may be started in which a high-pressure process reforms the cheese trim 10 into a desirable shape 20 and size. This may be accomplished without changing temperatures so that the profile of the desirable shape 20, stays the same unless one chooses to change it by adding flavors 12. The reformed cheese 20, is then processed through a packaging line 35, for conversion into the original retail size 23, or as desired 23. As mentioned elsewhere, one can develop innovative flavor profiles using additional ingredients 12. Thus, innovative flavor profiles may be produced to allow the cheese trim or cheese curd 10, to be marketed and/or sold by providing identifiable flavor trends regionally, nationally, and/or globally.

It should be appreciated that the invention is the first of its kind and provides several advantages that not only reduce major concerns to the manufacturers and/or private label companies pertaining to cheese trim and/or waste, but it also greatly benefits the dairy industry by its creation of innovative natural flavored cheese curd profiles. This unique and novel invention furthers the quest to promote and distribute cheese products, especially cheese curd products 20 both locally and throughout the globe. It should be further appreciated that the cheese curd log 20, or cheese curd stick 20, or cheese curd snack stick 20, could have a diameter size as desired, for example, between about one half (½) inch and ten (10) inches with the length being variable and/or as desired by a consumer, a user and/or a manufacturer. Also, as shown in the figures, the cross-sectional shape of the cheese curd log 20, or the cheese curd stick 20, may be any shape desired, such as rectangular shape, square shape, round shape, triangular shape, multisided shape, polygonal shape and/or any combination thereof, to name a few.

It should be appreciated that while the invention has been described with reference to an exemplary embodiment, it will be understood by those skilled in the art that various changes, omissions and/or additions may be made, and equivalents may be substituted for elements thereof without departing from the spirit and scope of the invention. Moreover, embodiments and/or elements of embodiments contemplated and/or disclosed herein may be combined as desired. In addition, many modifications may be made to adapt a particular situation or material to the teachings of the invention without departing from the scope thereof. Therefore, it is intended that the invention is not limited to the particular embodiment disclosed as the best mode contemplated for carrying out this invention, but that the invention will include all embodiments falling within the scope of the appended claims and/or information. Moreover, unless specifically stated any use of the terms first, second, etc. do not denote any order or importance, but rather the terms first, second, etc. are used to distinguish one element from another.

What is claimed is:

1. A cheese curd log, comprising:
a cheese curd log first end,
a cheese curd log second end, and
a cheese curd log length,
wherein the cheese curd log length extends between the cheese curd log first end and the cheese curd log second end,
wherein the cheese curd log is formed into a log via an extrusion process using an extrusion device.
